(19) United States
(12) Patent Application Publication
(10) Pub. No.: US 2007/0043144 A1
(43) Pub. Date: Feb. 22, 2007

(54) Pigment ink jet ink composition

(75) Inventors: Gary L. House, Victor, NY (US); Xiaoru Wang, Webster, NY (US); Allan F. Sowinski, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/206,588

(22) Filed: Aug. 18, 2005

(51) Int. Cl. C03C 17/00

(52) U.S. Cl. 523/160

(57) ABSTRACT

An ink jet ink composition comprising an aqueous media and a pigment dispersion comprising a pigment and a polymeric dispersant wherein said polymeric dispersant is a copolymer comprising at least a hydrophobic methacrylate or acrylate monomer containing an aliphatic chain having greater than or equal to 12 carbons; and a hydrophilic methacrylic or acrylic acid monomer; wherein said copolymer comprises at least 10% by weight of the methacrylate or acrylate monomer and at least 5% by weight of the methacrylic or acrylic acid monomer; and wherein the copolymer comprises, in total, 20 to 95 weight % of hydrophobic monomer.

### FIELD OF THE INVENTION

This invention relates to polymeric pigment dispersions suitable for ink jet printing. The pigment dispersions are particularly useful in aqueous-based ink compositions that are to be printed onto a variety of receivers and papers.

### BACKGROUND OF THE INVENTION

Ink jet printing is a non-impact method for producing printed images by the deposition of ink droplets in a pixel-by-pixel manner to an image-recording element in response to digital signals. There are various methods that may be utilized to control the deposition of ink droplets on the image-recording element to yield the desired printed image. In one process, known as drop-on-demand ink jet, individual droplets are projected as needed onto the image-recording element to form the desired printed image. Common methods of controlling the ejection of ink droplets in drop-on-demand printing include thermal bubble formation (thermal ink jet (TIJ)) and piezoelectric transducers. In another process known as continuous ink jet (CIJ), a continuous stream of droplets is generated and expelled in an image-wise manner onto the surface of the image-recording element, while non-imaged droplets are deflected, caught and recycled to an ink sump. Ink jet printers have found broad applications across markets ranging from desktop document and photographic-quality imaging, to short run printing and industrial labeling.

Ink compositions used in ink jet printers can be classified as either pigment-based in which the colorant exists as pigment particles suspended in the ink composition, or as dye-based in which the colorant exists as a fully solvated dye species that consists of one or more dye molecules. Pigment-based inks are often preferred over dye-based inks because they possess better resistance to light and gas, especially ozone, as compared to printed images with dye-based inks.

Today, virtually all pigment-based ink compositions used in photographic quality ink jet printing have pigment particles in the nanometer-size range. It is well known in the art that when light strikes the surface of a printed image, light scattering at many angles occurs if particles at the surface of a printed image are greater than 300 nm or about the shortest wavelength of visible light. Such light scattering is detrimental because optical density is reduced. This is especially important on photo-glossy receivers typically used for printing of photographic quality images where both good gloss and density are critical to image quality. As such, pigment-based ink compositions used in today's ink jet printers have median pigment particle diameters less than about 200 nm. Pigment-based ink compositions having pigment particles with an average diameter of less than about 100 nm are known and are particularly desirable because they not only provide high densities and good gloss, but are easier to jet through print heads having small nozzle diameters, for example, less than 25 um.

The process of preparing pigment-based ink compositions usually involves two sequential steps: (a) a milling step, conducted in the presence of a dispersing agent, to break up crude pigment aggregates into primary pigment particles that are stabilized by the dispersing agent, and (b) an ink formulation step in which the stabilized pigment dispersion particles are diluted with ink components such as water and water miscible organic compounds (humectants, surfactants, binders, etc.). It is well known in the art that the choice of dispersant in the milling step is critical as it facilitates de-aggregation and stabilization of the pigment agglomerates as they are being broken up by the mechanical and kinetic energy being provided in the milling process. The choice of dispersant ultimately affects the primary particle size achievable and also determines many of the final physical properties of the dispersion, such as viscosity and surface tension. The dispersant also strongly influences the stability of the dispersion to various ink additives, the jetting quality of the ink, and the final printed image resistance to degradations associated with wet and dry physical abrasion, light and gas fade, and water-fastness.

The pigment particles of pigment-based ink compositions, when printed onto photo-glossy receivers suitable for photographic image quality, typically reside at the surface of the receiver material. As noted above this provides high optical density for such images. The same pigmented ink compositions, when printed onto uncoated (plain) papers typically used in the home or office environment for routine printing, often provide less density and colorfulness as compared to dye-based inks. This is a result of the pigment particles of the pigment-based ink compositions migrating into the interior of the plain paper. Consequently, the pigment particles receive reduced illumination by incident light, and the light scatter that occurs within the plain paper further diminishes the density formed by the pigment particles. In contrast, appreciable colorant in the dye-based ink compositions is absorbed by the paper fibers at or near the surface of the plain paper, which results in higher optical density.

Thus, a major challenge for pigmented ink compositions comprised of polymerically-dispersed pigment particles is to provide high density and colorfulness when printed onto uncoated papers, while simultaneously providing high density, gloss, and image durability on glossy papers and photo-glossy ink jet receivers. There have been a number of approaches to solve this problem. For example, it is known in the art that self-dispersed pigments, commonly used in black pigmented ink compositions used for printing text, are able to provide high density on uncoated papers (T. Lüthge, G. Tauber, R. McIntosh, W. Kalbitz, and S. Lüdtke, Proc. NIP 20: Int. Conf. on Digital Printing Tech., 2004, IS&T, Springfield, Va., pp 753-757; U.S. Pat. No. 5,672,198 A to J. Belmont). Such inks, unfortunately, lack water fastness and good smear properties on these receivers. Additionally, when such inks are printed onto photo-glossy receivers they provide black images of very low gloss and poor smear resistance rendering their use unsuitable for black-and-white photo-printing. Extensions of self-dispersed pigmented inks to other colors such as cyan, magenta, and yellow have not yet been successful commercially.

Approaches that utilize high molecular weight polymeric dispersants and latexes in the pigmented ink compositions have been employed in drop-on-demand piezoelectric printhead printers directed at photographic quality pictorial image reproduction (U.S. Pat. No. 6,713,531 B2; U.S. Pat. No. 6,180,691 B1; U.S. Pat. No. 6,866,707 B2). Such inks provide high density on uncoated papers and high density, durable images of modest gloss on photo-glossy receivers. Unfortunately, pigmented inks of such compositions cannot be utilized in thermal ink jet since heaters become easily fouled and small diameter nozzles clogged. Other approaches relying on polymeric dispersants containing high hydrophobic to hydrophilic monomer ratios, not suited for aqueous milling processes, have also been disclosed (U.S. Pat. No. 5,798,426 A issued to Anton et al.). Approaches to modify the uncoated paper compositions by incorporating cationic species capable of binding the pigment particles near the surface of the uncoated receiver have also been employed. Such approaches typically increase the cost of the receiver or complicate the paper making process and have not generally been utilized in uncoated receivers commonly used in the home or office.

U.S. Patent Application 2005/0143491 describes certain block copolymers to beutilized in anon-aqueous ink jet ink. U.S. Pat. No. 5,679,138 A, U.S. Pat. No. 5,651,813 A, and U.S. Pat. No. 5,985,017 A describe the preparation of aqueous pigment-based ink compositions for ink jet printing wherein pigment particles are dispersed with surfactants and have an average particle diameter of less than 100 nm. Although these ink compositions are very useful for photographic-quality imaging, the ink compositions therein may not possess sufficient durability on photo-glossy receivers nor provide high density and colorfulness on a variety of receivers, including uncoated papers. U.S. Patent 2005/0004261 A1, U.S. Patent 2004/0127619 A1, U.S. Pat. No. 6,245,832 B1, U.S. Pat. No. 5,085,698 A, and U.S. Pat. No. 4,597,794 A describe aqueous pigment-based ink compositions for ink jet printing wherein pigment particles are dispersed with polymeric materials derived from hydrophobic and hydrophilic monomers. Use of these dispersants and milling processes provides dispersions that frequently have particle sizes equal to or greater than 100 nm. Pigment-based ink compositions produced from such dispersions do not yield the necessary density and colorfulness on uncoated papers. U.S. Ser. No. 10/891316, filed Jul. 14, 2004, describes the preparation of aqueous pigmented ink compositions for ink jet printing wherein the pigment particles are dispersed with random copolymers and have an median particle diameter less than about 100 nm. While these pigment-based ink compositions provide high durability and density in drop-on-demand image printing applications, they lack the necessary density and colorfulness on uncoated papers.

Continuous ink jet printing has related needs for improved ink compositions. High-speed continuous ink jet printing is used in commercial market applications and generally involves printing variable information for transactional documents such as invoices and credit card billing statements, and also scratch-off lottery tickets. Variable-data imprinting sub-systems, consisting of a printhead, control electronics, an ink reservoir, an ink pump and an ink delivery system, can be added to an existing high-speed press system for black text printing in labeling or mailing applications. Commonly used dye-based inks can provide adequate optical density on the normal mix of paper substrates, such as plain bond papers, surface-treated papers, or coated and calendared business gloss papers or heavy-stock covers. Dye-based inks, however, suffer poor waterfastness on all substrates, and low durability on glossy papers against wet rub abrasion that can render text and universal packaging code information illegible. Self-dispersed carbon black pigment-based ink compositions lacking a film-forming polymer binder offer high optical density on untreated bond papers that approach electrophotographic-printing quality, with values of about 1.4. The colorant, however, is readily redispersed by wet rub abrasion, resulting in undesirably low durability. Polymer-dispersed carbon black pigment ink compositions of the art offer excellent waterfastness, wet rub durability, and dry rub abrasion on all substrates, but optical density suffers on plain papers, where the colorant apparently wicks along the cellulose fibers into the interior of the paper, leading to grayish appearing printed text. A continuous ink jet printing ink composition comprised of carbon black pigment and an associated water soluble polymer resin is described in EP 0 853 106 B1 to Thakkar et al., in U.S. Pat. No. 6,023,605 B1 to Thakkar et al., and in U.S. Pat. No. 5,512,089 B1 to Thakkar, the disclosures of which are incorporated herein by reference.

It is not appreciated in the art that the choice of polymeric dispersant, especially the choice of certain monomer types, will markedly influence the interaction of the pigment particles in pigment-based ink compositions with the surface of uncoated papers. Generally, polymeric dispersants have been selected for their ability to provide stable pigment dispersions and pigmented ink compositions that enable improved performance on photo-glossy receivers while providing good jetting quality within the printing architecture they must operate.

The need remains to provide pigment-based ink compositions that meet all the needs of photographic-quality imaging on both coated substrates (photo-receivers) and uncoated substrates (plain papers and the like) that can be readily and reliably printed by both thermal and piezoelectric drop-on-demand ink jet printers. For continuous ink jet printers, a related long-standing need remains to produce high optical density on plain papers while preserving glossy paper substrate wet rub durability.

### SUMMARY OF THE INVENTION

The heretofore unmet needs are provided by an ink jet ink composition comprising an aqueous media and a pigment dispersion comprising a pigment and a polymeric dispersant wherein said polymeric dispersant is a copolymer comprising at least a hydrophobic methacrylate or acrylate monomer containing an aliphatic chain having greater than or equal to 12 carbons; and a hydrophilic methacrylic or acrylic acid monomer; wherein said copolymer comprises at least 10% by weight of the methacrylate or acrylate monomer and at least 5% by weight of the methacrylic or acrylic acid monomer; and wherein the copolymer comprises, in total, 20 to 95 weight % of hydrophobic monomer. Preferably the copolymer is a random copolymer.

Also provided is an ink jet printing method comprising the steps of:

A) providing an ink jet printer that is responsive to digital data signals;

B) loading the printer with an ink jet recording element comprising an uncoated or coated ink receiving substrate;

C) loading the printer with an ink jet ink composition comprising a pigment dispersion, water and a water-miscible organic compound; wherein the pigment dispersion comprises pigment particles having a median diameter of 200 nm or less, and a polymeric dispersant that is a copolymer comprising at least a hydrophobic methacrylate or acrylate monomer containing an aliphatic chain having greater than or equal to 12 carbons; and a hydrophilic methacrylic or acrylic acid monomer; wherein said copolymer comprises at least 10% by weight of the methacrylate or acrylate monomer and at least 5% by weight of the methacrylic or acrylic acid monomer; and wherein the copolymer comprises, in total, 20 to 95 weight % of hydrophobic monomer, wherein the polymeric dispersant has a weight average molecular weight of less than 25,000; and

D) printing on the image receiving element using the ink jet composition in response to the digital data signals.

### ADVANTAGEOUS EFFECT OF THE INVENTION

The invention provides numerous advantages. The invention provides a pigment dispersion and pigment-based ink composition capable of providing images of high optical density and colorfulness on uncoated receivers; such images are comparable to those achieved with dyes. At the same time these pigment-based ink compositions meet all the key requirements for photographic image quality and durability on coated papers designed for photo-printing. The invention also provides a pigment dispersion that is stable to a variety of ink formulations suited to modem-day ink jet printers thus allowing the ink formulator wide latitude in ink design. The invention further provides pigment-based ink compositions that are tolerant of extreme temperature ranges.

The invention provides inks that can be jetted easily in both thermal and piezoelectric drop-on-demand printers and continuous ink jet ink printers. The small pigment particle sizes in the pigment-based ink compositions ensure that print head nozzles do not clog even after hundreds or thousands of pages are printed. Ink compositions of the invention are capable of rendering high density and photographic-quality printed images when printed on a variety of ink jet recording substrates, even those having high gloss, and such printed images exhibit fine durability and long term stability to environmental factors such as light and gas (ozone). Ink compositions of the invention upon drying provide superior resistance to physical abrasion (rub and scratch) even without the addition of protective polymeric binders.

### DETAILED DESCRIPTION OF THE INVENTION

The ink jet ink composition of the invention is comprised of a pigment dispersion consisting of pigment colorant particles in association with a polymeric dispersant. The polymeric dispersants useful in the present invention are copolymers prepared from at least one hydrophilic monomer that is an acrylic acid or methacrylic acid monomer, or combinations thereof. Preferably, the hydrophilic monomer is methacrylic acid. The hydrophilic monomer is present in the copolymer in an amount of at least 5% based on the total weight of the copolymer, and more preferably at least 15% of the total weight.

The polymeric dispersants of the invention also comprise at least one hydrophobic monomer. The hydrophobic monomer used to prepare the polymeric dispersant of the present invention is comprised of a carboxylic acid ester-containing functional group. The hydrophobic monomers may be selected from any aliphatic acrylate or methocrylate monomer provided it contains an aliphatic chain comprising greater than or equal to 12 carbon atoms. The chains comprising greater than or equal to 12 carbons may be linear or branched. Examples of specific hydrophobic monomers useful in the present invention include the following: lauryl acrylate, lauryl methacrylate, tridecyl acrylate, tridecyl methacrylate, tetradecyl acrylate, tetradecyl methacrylate, cetyl acrylate, iso-cetyl acrylate, stearyl methacrylate, iso-stearyl methacrylate, stearyl acrylate, stearyl methacrylate, decyltetradecyl acrylate, decyltetradecyl methacrylate, and the like. Preferably the methacrylate or acrylate monomer is stearyl or lauryl methacrylate or acrylate. The hydrophobic portion of the polymer may be prepared from one or more of the hydrophobic monomers.

The hydrophobic monomer having a carbon chain length of greater than or equal to 12 carbons is present in an amount of at least 10% by weight of the total copolymer, and more preferably greater than 20% by weight. The copolymer may also comprise, in addition to the hydrophobic monomer comprising greater than or equal to 12 carbon chains, a hydrophobic monomer comprising an aromatic group. For example, the additional aromatic group containing monomer may be benzyl acrylate or benzyl methacrylate. A preferred additional monomer is benzyl methacrylate.

The total amount of hydrophobic monomers, comprising the monomer having a chain with greater than or equal to 12 carbons and optionally, monomer containing an aromatic group, are present in the polymer in an amount of 20 to 95% by weight of the total polymer. The hydrophobic aromatic-group containing monomer may be present in an amount from about 0 to 85% by weight of the total polymer, more preferably from about 0 to 60%, and most preferably from about 0 to 50%.

The polymeric dispersant (copolymer) of the present invention is not limited in the arrangement of the monomers comprising the copolymer. The arrangement of monomers may be totally random, or they may be arranged in blocks such as AB or ABA wherein, A is the hydrophobic monomer and B is the hydrophilic monomer. In addition, the polymer make take the form of a random terpolymer or an ABC triblock wherein, at least one of the A, B and C blocks is chosen to be the hydrophilic monomer and the remaining blocks are hydrophobic blocks dissimilar from one another. Preferably the copolymer is a random copolymer.

The weight average molecular weight of the copolymer of the present invention has an upper limit such that it is less than about 50,000 daltons. Desirably the weight average molecular weight of the copolymer is less than about 25,00 daltons; more preferably it is less than 15,000 and most preferably less than 10,000 daltons. The molecular weight of the copolymer of the present invention has a weight average molecular weight lower limit such that it is greater than about 500 daltons.

The pigment particles of the pigment-based ink composition of the present invention have a median particle diameter of less than 200 nm and more preferably less than 100 nm. As used herein, median particle diameter refers to the 50th percentile such that 50% of the volume of the particles is composed of particles having diameters smaller than the indicated diameter. Pigment-based ink compositions useful in the invention may be prepared by any method known in the art of ink jet printing. Useful methods commonly involve two steps: (a) a dispersing or milling step to break up the pigment aggregate into primary particles, where primary particle is defined as the smallest identifiable subdivision in a particulate system, and (b) a dilution step in which the pigment dispersion from step (a) is diluted with the remaining ink components to give a working strength ink.

The milling step (a) is carried out using any type of grinding mill such as a media mill, a ball mill, a two-roll mill, a three-roll mill, a bead mill, and air-jet mill, an attritor, or a liquid interaction chamber. In the milling step (a), pigments are optionally suspended in a medium, which is typically the same as, or similar to, the medium used to dilute the pigment dispersion in step (b). Inert milling media are optionally present in the milling step (a) in order to facilitate break up of the pigments to primary particles. Inert milling media include such materials as polymeric beads, glasses, ceramics, metals and plastics as described, for example, in U.S. Pat. No. 5,891,231. Milling media are removed from either the pigment dispersion obtained in step (a) or from the ink composition obtained in step (b).

The dispersant of the present invention is preferably present in the milling step (a) in order to facilitate break up of the pigment agglomerate into primary particles. For the pigment dispersion obtained in step (a) or the ink composition obtained in step (b), the dispersant is present in order to maintain particle stability and prevent settling. In addition to the polymer dispersants of the present invention, there may be, optionally, additional dispersants present for use in the invention such as those commonly used in the art of ink jet printing. For aqueous pigment-based ink compositions, useful dispersants include anionic, or nonionic surfactants such as sodium dodecylsulfate, or potassium or sodium oleylmethyltaurate as described in, for example, U.S. Pat. No. 5,679,138, U.S. Pat. No. 5,651,813, or U.S. Pat. No. 5,985,017.

A wide variety of organic and inorganic pigments, alone or in combination with each other, may be used in the ink composition of the present invention. For example, a carbon black pigment may be combined with a colored pigment such as a cyan copper phthalocyanine or a magenta quinacridone pigment in the same ink composition. Pigments that may be used in the invention include those disclosed in, for example, U.S. Pat. Nos. 5,026,427, 5,086,698, 5,141,556, 5,160,370, and 5,169,436. The exact choice of pigments will depend upon the specific application and performance requirements such as color reproduction and image stability. Pigments suitable for use in the invention include, but are not limited to, azo pigments, monoazo pigments, disazo pigments, azo pigment lakes, β-Naphthol pigments, Naphthol AS pigments, benzimidazolone pigments, disazo condensation pigments, metal complex pigments, isoindolinone and isoindoline pigments, polycyclic pigments, phthalocyanine pigments, quinacridone pigments, perylene and perinone pigments, thioindigo pigments, anthrapyrimidone pigments, flavanthrone pigments, anthanthrone pigments, dioxazine pigments, triarylcarbonium pigments, quinophthalone pigments, diketopyrrolo pyrrole pigments, titanium oxide, iron oxide, and carbon black. Preferably the pigment is carbon black.

Typical examples of pigments that may be used include Color Index (C.I.) Pigment Yellow 1, 2, 3, 5, 6, 10, 12, 13, 14, 16, 17, 62, 65, 73, 74, 75, 81, 83, 87, 90, 93, 94, 95, 97, 98, 99, 100, 101, 104, 106, 108, 109, 110, 111, 113, 114, 116, 117, 120, 121, 123, 124, 126, 127, 128, 129, 130, 133, 136, 138, 139, 147, 148, 150, 151, 152, 153, 154, 155, 165, 166, 167, 168, 169, 170, 171, 172, 173, 174, 175, 176, 177, 179, 180, 181, 182, 183, 184, 185, 187, 188, 190, 191, 192, 193, 194; C. I. Pigment Red 1, 2, 3, 4, 5, 6, 7, 8, 9, 10, 11, 12, 13, 14, 15, 16, 17, 18, 21, 22, 23, 31, 32, 38, 48:1, 48:2, 48:3, 48:4, 49:1, 49:2, 49:3, 50:1, 51, 52:1, 52:2, 53:1, 57:1, 60:1, 63:1, 66, 67, 68, 81, 95, 112, 114, 119, 122, 136, 144, 146, 147, 148, 149, 150, 151, 164, 166, 168, 169, 170, 171, 172, 175, 176, 177, 178, 179, 181, 184, 185, 187, 188, 190, 192, 194, 200, 202, 204, 206, 207, 210, 211, 212, 213, 214, 216, 220, 222, 237, 238, 239, 240, 242, 243, 245, 247, 248, 251, 252, 253, 254, 255, 256, 258, 261, 264; C.I. Pigment Blue 1, 2, 9, 10, 14, 15:1, 15:2, 15:3, 15:4, 15:6, 15, 16, 18, 19, 24:1, 25, 56, 60, 61, 62, 63, 64, 66, bridged aluminum phthalocyanine pigments; C.I. Pigment Black 1, 7, 20, 31, 32; C.I. Pigment Orange 1, 2, 5, 6, 13, 15, 16, 17, 17:1, 19, 22, 24, 31, 34, 36, 38, 40, 43, 44, 46, 48, 49, 51, 59, 60, 61, 62, 64, 65, 66, 67, 68, 69; C.I. Pigment Green 1, 2, 4, 7, 8, 10, 36, 45; C.I. Pigment Violet 1, 2, 3, 5:1, 13, 19, 23, 25, 27, 29, 31, 32, 37, 39, 42, 44, 50; or C.I. Pigment Brown 1, 5, 22, 23, 25, 38, 41, 42.

The inks of the invention could also optionally comprise, in addition to the pigment dispersion, self-dispersing pigments that are dispersible without the use of a dispersant or surfactant may also be useful in the invention. Pigments of this type are those that have been subjected to a surface treatment such as oxidation/reduction, acid/base treatment, or functionalization through coupling chemistry. The surface treatment can render the surface of the pigment with anionic, cationic or non-ionic groups. Examples of self-dispersing type pigments include, but are not limited to, Cab-O-Jet® 200 and Cab-O-Jet® 300 (Cabot Corp.) and Bonjet® Black CW-1, CW-2, and CW-3 (Orient Chemical Industries, Ltd.).

The pigments used in the ink composition of the invention may be present in any effective amount, generally from 0.1 to 10% by weight, and preferably from 0.5 to 6% by weight. In one embodiment the weight ratio of the copolymer to the pigment is 0.15 to 0.8.

The inks of the invention could also optionally comprise, in addition to the pigment dispersion, dyes known in the art of ink jet printing. For aqueous-based ink compositions dyes suitable for use in the invention include, but are not limited to, water-soluble reactive dyes, direct dyes, anionic dyes, cationic dyes, acid dyes, food dyes, metal-complex dyes, phthalocyanine dyes, anthraquinone dyes, anthrapyridone dyes, azo dyes, rhodamine dyes, solvent dyes and the like. Specific examples of dyes usable in the present invention are as follows: yellow dyes including: C.I. Acid Yellow 1, 3, 11, 17, 19, 23, 25, 29, 36, 38, 40, 42, 44, 49, 59, 61, 70, 72, 75, 76, 78, 79, 98, 99, 110, 111, 127, 131, 135, 142, 162, 164, and 165; C.I. Direct Yellow 1, 8, 11, 12, 24, 26, 27, 33, 39, 44, 50, 58, 85, 86, 87, 88, 89, 98, 110, 132, 142, and 144; C.I. Reactive Yellow 1, 2, 3, 4, 6, 7, 11, 12, 13, 14, 15, 16, 17, 18, 22, 23, 24, 25, 26, 27, 37, and 42; and C.I. Food Yellow 3 and 4; magenta dyes including: C.I. Acid Red 1, 6, 8, 9, 13, 14, 18, 26, 27, 32, 35, 37, 42, 51, 52, 57, 75, 77, 80, 82, 85, 87, 88, 89, 92, 94, 97, 106, 111, 114, 115, 117, 118, 119, 129, 130, 131, 133, 134, 138, 143, 145, 154, 155, 158, 168, 180, 183, 184, 186, 194, 198, 209, 211, 215, 219, 249, 252, 254, 262, 265, 274, 282, 289, 303, 317, 320, 321, and 322; C.I. Direct Red 1, 2, 4, 9, 11, 13, 17, 20, 23, 24, 28, 31, 33, 37, 39, 44, 46, 62, 63, 75, 79, 80, 81, 83, 84, 89, 95, 99, 113, 197, 201, 218, 220, 224, 225, 226, 227, 228, 229, 230, and 231; C.I. Reactive Red 1, 2, 3, 4, 5, 6, 7, 8, 11, 12, 13, 15, 16, 17, 19, 20, 21, 22, 23, 24, 28, 29, 31, 32, 33, 34, 35, 36, 37, 38, 39, 40, 41, 42, 43, 45, 46, 49, 50, 58, 59, 63, and 64; and C.I. Food Red 7, 9, and 14; cyan dyes including: C.I. Acid Blue 1, 7, 9, 15, 22, 23, 25, 27, 29, 40, 41, 43, 45, 54, 59, 60, 62, 72, 74, 78, 80, 82, 83, 90, 92, 93, 100, 102, 103, 104, 112, 113, 117, 120, 126, 127, 129, 130, 131, 138, 140, 142, 143, 151, 154, 158, 161, 166, 167, 168, 170, 171, 182, 183, 184, 187, 192, 199, 203, 204, 205, 229, 234, 236, and 249; C.I. Direct Blue 1, 2, 6, 15, 22, 25, 41, 71, 76, 77, 78, 80, 86, 87, 90, 98, 106, 108, 120, 123, 158, 160, 163, 165, 168, 192, 193, 194, 195, 196, 199, 200, 201, 202, 203, 207, 225, 226, 236, 237, 246, 248, and 249; C.I. Reactive Blue 1, 2, 3, 4, 5, 7, 8, 9, 13, 14, 15, 17, 18, 19, 20, 21, 25, 26, 27, 28, 29, 31, 32, 33, 34, 37, 38, 39, 40, 41, 43,44, and 46; and C. I. Food Blue 1 and 2; black dyes including: C.I. Acid Black 1, 2, 7, 24, 26, 29, 31, 48, 50, 51, 52, 58, 60, 62, 63, 64, 67, 72, 76, 77, 94, 107, 108, 109, 110, 112, 115, 118, 119, 121, 122, 131, 132, 139, 140, 155, 156, 157, 158, 159, and 191; C.I. Direct Black 17, 19, 22, 32, 39, 51, 56, 62, 71, 74, 75, 77, 94, 105, 106, 107, 108, 112, 113, 117, 118, 132, 133, 146, 154, and 168; C.I. Reactive Black 1, 3, 4, 5, 6, 8, 9, 10, 12, 13, 14, 31, and 18; and C.I. Food Black 2, CAS No. 224628-70-0 sold as JPD Magenta EK-1 Liquid from Nippon Kayaku Kabushiki Kaisha; CAS No. 153204-88-7 sold as Intrajet® Magenta KRP from Crompton and Knowles Colors; the metal azo dyes disclosed in U.S. Pat. Nos. 5,997,622 and 6,001,161.

It is also contemplated that the ink compositions of the present invention may also contain non-colored particles such as inorganic particles or polymeric particles. The use of such particulate addenda has increased over the past several years, especially in ink jet ink compositions intended for photographic-quality imaging. For example, U.S. Pat. No. 5,925,178 describes the use of inorganic particles in pigment-based inks in order to improve optical density and rub resistance of the pigment particles on the image-recording element. In another example, U.S. Pat. No. 6,508,548 B2 describes the use of a water-dispersible polymeric latex in dye-based inks in order to improve light and ozone resistance of the printed images. The ink composition may contain non-colored particles such as inorganic or polymeric particles in order to improve gloss differential, light and/or ozone resistance, waterfastness, rub resistance and various other properties of a printed image; see for example, U.S. Pat. No. 6,598,967 B1 or U.S. Pat. No. 6,508,548 B2.

Examples of inorganic particles useful in the invention include, but are not limited to, alumina, boehmite, clay, calcium carbonate, titanium dioxide, calcined clay, aluminosilicates, silica, or barium sulfate. Examples of polymeric particles useful in the invention include; water-dispersible polymers generally classified as either addition polymers or condensation polymers, both of which are well-known to those skilled in the art of polymer chemistry. Examples of polymer classes include acrylics, styrenics, polyethylenes, polypropylenes, polyesters, polyamides, polyurethanes, polyureas, polyethers, polycarbonates, polyacid anhydrides, and copolymers consisting of combinations thereof. Such polymer particles can be ionomeric, film-forming, non-film-forming, fusible, or heavily cross-linked and can have a wide range of molecular weights and glass transition temperatures.

Examples of useful polymeric particles are styrene-acrylic copolymers sold under the trade names Joncryl® (S. C. Johnson Co.), Ucar™ (Dow Chemical Co.), Jonrez® (MeadWestvaco Corp.), and Vancryl® (Air Products and Chemicals, Inc.); sulfonated polyesters sold under the trade name Eastman AQ® (Eastman Chemical Co.); polyethylene or polypropylene resin emulsions and polyurethanes (such as the Witcobonds® from Witco Corp.). These polymeric particles are preferred because they are compatible in typical aqueous-based ink compositions, and because they render printed images that are highly durable towards physical abrasion, light and ozone.

The non-colored particles used in the ink composition of the invention may be present in any effective amount, generally from 0.01 to 20% by weight, and preferably from 0.01 to 6% by weight. The exact choice of non-colored particles will depend upon the specific application and performance requirements of the printed image.

Ink compositions may also contain water-soluble polymers often referred to as resins or binders in the art of inkjet ink compositions. The water-soluble polymers useful in the ink composition are differentiated from polymer particles in that they are soluble in the water phase or combined water/water-soluble solvent phase of the ink. Included in this class of polymers are nonionic, anionic, amphoteric and cationic polymers. Representative examples of water soluble polymers include, polyvinyl alcohols, polyvinyl acetates, polyvinyl pyrrolidones, carboxymethyl cellulose, polyethyloxazolines, polyethyleneimines, polyamides and alkali soluble resins, polyurethanes (such as those found in U.S. Pat. No. 6,268,101), polyacrylic acids, styrene-acrylic methacrylic acid copolymers (such as Joncryl® 70 from S.C. Johnson Co., TruDot® IJ-4655 from MeadWestvaco Corp., and Vancryl® 68S from Air Products and Chemicals, Inc.

Ink compositions useful in the invention may include humectants and/or co-solvents in order to prevent the ink composition from drying out or crusting in the nozzles of the printhead, to aid solubility of the components in the ink composition, or to facilitate penetration of the ink composition into the image-recording element after printing. Representative examples of humectants and co-solvents used in aqueous-based ink compositions include (1) alcohols, such as methyl alcohol, ethyl alcohol, n-propyl alcohol, iso-propyl alcohol, n-butyl alcohol, sec-butyl alcohol, t-butyl alcohol, iso-butyl alcohol, furfuryl alcohol, and tetrahydrofurfuryl alcohol; (2) polyhydric alcohols, such as ethylene glycol, di(ethylene glycol), tri(ethylene glycol), tetra(ethylene glycol), propylene glycol, poly(ethylene glycol), poly(propylene glycol), 1,2-propanediol, 1,3-propanediol, 1,2-butanediol, 1,3-butanediol, 1,4-butanediol, 1,2-pentanediol, 1,5-pentanediol, 1,2-hexanediol, 1,6-hexanediol, 2-methyl-2,4-pentanediol, 1,2-heptanediol, 1,7-hexanediol, 2-ethyl-1,3-hexanediol, 1,2-octanediol, 2, 2,4-trimethyl-1,3-pentanediol, 1,8-octanediol, glycerol, 1,2,6-hexanetriol, 2-ethyl-2-hydroxymethyl-propanediol, saccharides and sugar alcohols and thioglycol; (3) lower mono- and di-alkyl ethers derived from the polyhydric alcohols; such as, ethylene glycol monomethyl ether, ethylene glycol monobutyl ether, ethylene glycol monoethyl ether acetate, di(ethylene glycol) monomethyl ether, and di(ethylene glycol) monobutyl ether acetate (4) nitrogen-containing compounds such as urea, 2-pyrrolidone, N-methyl-2-pyrrolidone, and 1,3-dimethyl-2-imidazolidinone; and (5) sulfur-containing compounds such as 2,2′-thiodiethanol, dimethyl sulfoxide and tetramethylene sulfone.

Typical aqueous-based ink compositions useful in the invention directed at drop-on-demand ink jet printing may contain, for example, the following components based on the total weight of the ink: water 20-95%, humectant(s) 0-70%, and co-solvent(s) 0-20%.

Particularly preferred water soluble organic solvents useful in ink compositions directed at drop-on-demand printing applications containing the pigment and polymeric dispersants of the invention are tri(ethylene glycol) or poly(ethylene glycol) homopolymers having number average molecular weights ranging from about 200 to 1000, or mixtures of these solvents. Ink compositions containing tri(ethylene glycol) or poly(ethylene glycol) solvents used in the range of about 1 to 15% based on total ink weight are preferred, from 3 to 12% are more preferred and from 4 to 10% are most preferred.

Surfactants may be added to the ink composition to adjust the surface tension of the ink to an appropriate level provided that they do not compromise the colloidal stability of the pigment particles. The surfactants may be anionic, cationic, amphoteric or nonionic and used at levels of about 0.01 to 5% of the ink composition. Examples of suitable nonionic surfactants include, linear or secondary alcohol ethoxylates (such as the Tergitol® 15-S and Tergitol® TMN series available from Union Carbide Corp. and the Brij® series from Uniquema®, Imperial Chemical Industries PLC), ethoxylated alkyl phenols (such as the Triton® series from Union Carbide Corp.), fluoro surfactants (such as the Zonyls® from DuPont; and the Fluorads® from 3M Co.), fatty acid ethoxylates, fatty amide ethoxylates, ethoxylated and propoxylated block copolymers (such as the Pluronic® and Tetronic® series from BASF, ethoxylated and propoxylated polysiloxane based surfactants (such as the Silwet® series from GE Silicones, General Electric Co.), and acetylenic polyethylene oxide surfactants (such as the Surfynols® from Air Products and Chemicals, Inc.).

Examples of anionic surfactants include; carboxylated (such as ether carboxylates and sulfosuccinates), sulfated (such as sodium dodecyl sulfate), sulfonated (such as dodecyl benzene sulfonate, alpha olefin sulfonates, alkyl diphenyl oxide disulfonates, fatty acid taurates and alkyl naphthalene sulfonates), phosphated (such as phosphate esters of alkyl and aryl alcohols, including the Strodex® series from Dexter Chemical LLC.), phosphonated and amine oxide surfactants and anionic fluorinated surfactants. Examples of amphoteric surfactants include; betaines, sultaines, and aminopropionates. Examples of cationic surfactants include; quaternary ammonium compounds, cationic amine oxides, ethoxylated fatty amines and imidazoline surfactants. Additional examples are of the above surfactants are described in McCutcheon 's Emulsifiers and Detergents North American Edition International Edition 1996 Annuals, Vol. 1, McCutcheon Division of Manufacturing Confectionar Co., Glen Rock, N.J. (1996).

A biocide may be added to an ink jet ink composition to suppress the growth of microorganisms such as bacteria, molds, fungi, etc. in aqueous inks. Useful preservatives are exemplified by alkylisothiazolones, chloroalkylisothiazolones, and benzisothiazolones. Preferred commercial products for use in an ink composition include Proxel® GXL (Arch Chemicals, Inc.) and Kordek® MLX (Rohm and Haas Co.) at a final concentration of 0.0001-0.5 wt. %. Additional additives which may optionally be present in an ink jet ink composition include thickeners, conductivity enhancing agents, anti-kogation agents, drying agents, waterfastness agents, dye solubilizers, chelating agents, binders, light stabilizers, viscosifiers or thickeners, buffering agents, anti-mold agents, anti-cockle agents, anti-curl agents, stabilizers, antifoamants and defoamers.

The pH of the aqueous ink compositions of the invention may be adjusted by the addition of organic or inorganic acids or bases. Useful inks may have a preferred pH of from about 2 to 11, depending upon the type of dye or pigment being used. Typical inorganic acids include hydrochloric, phosphoric and sulfuric acids. Typical organic acids include methanesulfonic, acetic, oxalic and lactic acids. Typical inorganic bases include alkali metal hydroxides and carbonates. Typical organic bases include ammonia, dimethylethanolamine, triethanolamine, and tetramethylethlenediamine.

The exact choice of ink components will depend upon the specific application and performance requirements of the printhead from which they are jetted. Thermal and piezoelectric drop-on-demand printheads and continuous printheads each require ink compositions with a different set of physical properties in order to achieve reliable and accurate jetting of the ink, as is well known in the art of inkjet printing. Acceptable viscosities for drop-on-demand printing are no greater than 20 cP, and preferably in the range of about 1.0 to 6.0 cP. Acceptable surface tensions for drop-on-demand printing are no greater than 60 dynes/cm, preferably in the range of 20 dynes/cm to 50 dynes/cm, and most preferably in the range of 28 dynes/cm to 45 dynes/cm.

In contrast to sheet-fed drop-on-demand printing, CIJ is a very high speed printing process, and it is desired to operate paper roll-fed web transport presses at substrate transport speeds in excess of 300 m/s. Printing speed alone imposes some limitations on ink formulation relative to slower drop-on-demand printing techniques, simply on the basis of the short time requirements for adequately drying the printed substrate moving at full speed in the press before roll wind-up. Surprisingly, features of CIJ printhead operation can allow wider ink formulation latitude than is possible in DOD printing in other respects, however. Ink formulation considerations specific to traditional CIJ printing are described in W. Wnek, IEEE Trans. 1986, 1475-81, which elucidates the ink performance requirements for drop formation, deflection and catching of non-printing drops, recirculation of the ink to the printhead from the storage reservoir for future printing, and also for commercial ink-media image quality and durability.

An ink jet ink composition for use in a continuous ink jet printer desirably contains water as the principal vehicle or carrier medium, colorant, humectant, biocide, and surfactant; it can desirably further contain one or more types of other components, including and not limited to a film-forming binder or mordant, a solubilizing agent, a co-solvent, a base, an acid, a pH buffer, a wetting agent, a chelating agent, a corrosion inhibitor, a viscosity modifier, a penetrant, a wetting agent, an antifoamant, a defoamer, an antifungal agent, a jetting aid, a filament length modifier, a trace of multivalent cationic flocculating salt, a solution conductivity control agent, or a compound for suppressing electrostatic deflection charge shorts when ink dries on the charge ribbon electrodes. Compounds useful for increasing pigment ink dried film resistivity for suppressing charge lead shorts are described in U.S. Pat. No. 5,676,744 to Thakkar et al., the disclosure of which is herein incorporated in its entirety. Inorganic and organic ink additives useful for controlled flocculation of pigmented ink jet compositions for CIJ are described in U.S. 2004/0266908 A1.

The total humectant level of the ink jet ink composition for CIJ printing is desirably from 0 to about 8% by weight. The total humectant level of the ink is the sum of the individual sources of humectant ingredients, which may include humectant added directly during ink formulation, and for example humectant associated with a commercial biocide preparation as a supplemental ingredient, or with a commercial pigment dispersion preparation that may be present to prevent so-called “paint-flakes” of dried pigment cake forming around a bottle cap, as described in U.S. 2005/0075415 A1 to Harz et al. More desirably, the total humectant level is from about 1% to about 5%, in order to facilitate drying of the ink jet printing recording material in a high speed printer while simultaneously encouraging higher equilibrium moisture content in dried ink film on hardware for redispersion and clean-up by ink, or by start-up and shut-down fluids, or by a printhead storage fluid. As use herein in reference to ink jet ink compositions for use in a continuous ink jet printer, a humectant may be comprised of an alcohol, such as 2-propanol or 1-pentanol; a polyol, such as glycerol or ethylene glycol; a glycol ether, such as di(ethylene glycol), tri(ethylene glycol), poly(ethylene glycol)-400 (average Mₙ ca. 400, herein referred to as PEG-400 for convenience), or poly(propylene glycol)-425 (average Mn ca. 425); an aromatic glycol ether such as propylene glycol phenyl ether (e.g., Dowanol® PPh glycol ether) or an aliphatic glycol ether such as diethylene glycol mono-n-butyl ether or poly(ethylene glycol) methyl ether (average M, ca. 550); a lactam, such as 2-pyrrolidinone, N-methyl-2-pyrrolidinone, or polyvinylpyrrolidone; an alternative polar solvent such as dimethyl sulfoxide, N,N-dimethylformamide, acetamide, N-methylacetamide, N,N-diethylacetamide or morpholine; a polyvalent aliphatic organic alcohol such as 1,5-pentanediol, 1,2-hexanediol, 1,6-hexanediol, or 2-ethyl-2-hydroxymethyl-1,3-propanediol, or a saccharide such as sorbitol or fructose; or an urea. It is recognized that the effectiveness of the humectant in accomplishing water retention and wetting will depend on its chemical structure. When the humectant chemical structure produces lower water retention, higher levels of the humectant can be used without adversely affecting the drying rate of the printed ink.

The pigmented ink jet ink composition of the invention for use in a continuous ink jet printer can be comprised of an additional water soluble dye colorant, as disclosed in EP 1 132 440 A2 to Botros et al., and EP 0 859 036 A1 to J-D. Chen. The pH of the ink jet ink composition directed at CIJ is desirably adjusted from about 7 to about 12; more desirably, the pH is about 8 to 10. When the ink composition is used in hardware with nickel or nickel-plated apparatus components, an anticorrosion inhibitor such as the sodium salt of 4- or 5-methyl-1-H-benzotriazole is desirably added and the pH adjusted to be from about 10 to about 11. When the ink composition is used with printheads with components fabricated from silicon that are in contact with the fluid, the ink composition pH is desirably adjusted to be from about 7 to about 9.5; more desirably, the pH ranges from about 8 to about 9. In order to minimize the risk of excessively protonating carboxylate anions associated with polymeric dispersant that might render the ink composition more susceptible to pigment flocculation, pH levels lower than about 7 are desirably avoided. With hardware components fabricated from silicon in contact with the ink composition, pH levels higher than about 10 can induce significant rates of etch and corrosion that may impair the operation of the device over time. Amine bases especially desirable in the application of the invention to CIJ printing include 3-amino-1-propanol, N,N-dimethanolamine, NAN-dimethylethanolamine, N,N-diethylethanolamine, and triethanolamine.

In the preparation of the polymeric dispersant, the copolymer formed following completed reaction of the monomers (following treatment with a polymerization initiator) is reacted with a base to deprotonate acidic functional groups on the hydrophilic polymer segments, such as carboxylic acid groups, in order to solubilize the polymer for pigment milling. In one embodiment the copolymer is reacted with an organic base to deprotonate acidic functional groups. Inorganic bases such as potassium hydroxide can be used, however, amine base neutralization of the polymeric dispersants, from about 50 to 100% of the sites capable of being titrated, prior to pigment milling is also specifically contemplated. Wet rub durability of the printed ink can be improved by amine neutralization. Defoaming agents comprised of phosphate esters, polysiloxanes, or acetylenic diols are optionally used with the ink compositions directed at CIJ to minimize foam formation caused the fluid agitation associated with drop catching and ink recirculation.

In one embodiment of the invention, the ink jet ink composition for use in a continuous ink jet printer is printed by a method employing a plurality of drop volumes formed from a continuous fluid stream and non-printing drops of a different volume than printing drops are diverted by a drop deflection means into a gutter for recirculation, as disclosed in U.S. Pat. No. 6,588,888 B2 to Jeanmaire et al., U.S. Pat. No. 6,554,410 B2 to Jeanmaire et al., U.S. Pat. No. 6,682,182 B1 to Jeanmaire et al., U.S. 2003/0202054 A1 to Jeanmaire et al., U.S. Pat. No. 6,793,328 B2 to D. Jeanmaire, U.S. Pat. No. 6,866,370 B2 to D. Jeanmaire, U.S. Pat. No. 6,575,566 B1 to Jeanmaire et al., and U.S. Pat. No. 6,517,197 B2 to Hawkins et al., the disclosures of which are herein incorporated in their entirety by reference. In another preferred embodiment, the ink jet ink composition is printed using an apparatus capable of controlling the direction of the formed printing and non-printing drops by asymmetric application of heat to the fluid stream that initializes drop break-up and serves to steer the resultant drop, as disclosed in U.S. Pat. No. 6,079,821 B2 to Chwalek et al, and in U.S. Pat. No. 6,505,921 B2 to Chwalek et al., the disclosures of which are herein incorporated in their entirety by reference. Useful ink agitation, heated ink supply and printhead and fluid filtration means for CIJ pigmented ink jet ink compositions are described in U.S. Pat. No. 6,817,705 B13 to Crockett et al. Printer replenishing systems for maintaining ink quality and countering the effects of ink volatile component evaporation are described in U.S. Pat. No. 5,526,026 to M. Bowers, U.S. Pat. No. 5,473, 350 to Mader et al., and EP 0 597 628 A1 to Loyd et al.

The following examples are intended to illustrate, not to limit, the invention.

### EXAMPLES

### Example 1

Polymeric Dispersant Preparation

Inventive Polymeric Dispersant P-1

In a 1-liter, three-necked round-bottom flask equipped with a reflux condenser were mixed under nitrogen atmosphere 37.0 g of benzyl methacrylate, 30.0 g of stearyl methacrylate, and 33.0 g of methacrylic acid, 1.5 g of 1-dodecanethiol, 400 mL of methyl ethyl ketone, and 1.2 g of AIBN. The solution was stirred and purged with nitrogen for 20 minutes and heated to 70° C. in a constant temperature bath. After 24 hours, the resulting solution was cooled. The resulting polymer solution was mixed with water and potassium hydroxide to achieve 85% acid neutralization. Thereafter the whole mixture was distilled at 50° C. under reduced pressure to remove the organic solvent. The final polymer solution had a concentration of ca. 20 wt. % in water and its pH was ca. 7. The average number molecular weight was 5600 and the average weight molecular weight was 10800.

Inventive Polymeric Dispersant P-2

Using the same procedure as described above, 33.0 g of methacrylic acid and 67.0 g of stearyl methacrylate were polymerized, and then 85% acid neutralized using potassium hydroxide. The final polymer solution had a concentration of ca. 20 wt. % in water and its pH was ca. 7. The average number molecular weight was 4750 and the average weight molecular weight was 10100.

Inventive Polymeric Dispersant P-3

Using the same procedure as described above, 33.0 g of methacrylic acid and 67.0 g of lauryl methacrylate were polymerized, and then 85% acid neutralized using potassium hydroxide. The final polymer solution had a concentration of ca. 20 wt. % in water and its pH was ca.7. The average number molecular weight was 6690 and the average weight molecular weight was 12100.

Comparative Polymeric Dispersant CPD-1

In a 1-liter, three-neck round-bottom flask equipped with a reflux condenser, 37.0 g of styrene, 30.0 g of stearyl methacrylate, and 33.0 g of methacrylic acid, 0.5 g of 1-dodecanethiol, 300 mL of methyl ethyl ketone, and 0.25 g of AIBN were mixed under nitrogen atmosphere. The solution was stirred and purged with nitrogen for 20 minutes and heated to 70° C. in a constant temperature bath. After 24 hours, the resulting solution was cooled and added slowly to hexane with rapid stirring. A white precipitate appeared and was collected by filtration under suction and dried in vacuo to give a white powder. The resulting polymer was dissolved in water adjusted to pH 7 using potassium hydroxide to give a 20 wt. % solution of CPD-1.

Comparative Polymeric Dispersant CPD-2

The same procedure for CPD-1 was employed to make CPD-2, except that the monomers used were benzyl methacrylate and methacrylic acid in a 67/33-weight ratio, respectively.

Comparative Dispersant CD-3

This dispersant (potassium oleylmethyltaurate) was obtained from the Chemical Production Division of Eastman Kodak Company.

Comparative Polymeric Dispersant CPD-4

The same procedure for CPD-2 was employed to make CPD-3, except that the monomers used were benzyl methacrylate, hyrdroxyethyl acrylate, and methacrylic acid in a 37/30/33 weight ratio, respectively.

Pigment Dispersion Preparation

Comparative Magenta Pigment Dispersion M-1

A mixture of 470 g of polymeric beads (milling media) having a mean diameter of 50 micrometers, 53 g of Pigment Red 122 (Sun Chemical Corp.), and 106 g of a 20 wt. % aqueous solution of polymeric dispersant CPD-1 was prepared and diluted with distilled water to give a total slurry weight of 1000 g. The mixture was milled for one hour at 1000 RPM using a Premier Mill 2500 Hv laboratory dispersator equipped with a 3.8 cm Cowles blade, and then for an additional 23 hours at 2500 RPM while holding the temperature constant at 23° C. The mixture was then filtered through a 10-micrometer screen under vacuum to separate the milling media from the pigment dispersion. This filtrate was then filtered through a one-micrometer binder-free glass fiber filter (Pall Corp.) to obtain the final M-1 pigment dispersion having approximately 10 wt.-% of pigment. The ratio of polymeric dispersant to pigment was 0.4:1.0.

Median particle diameter of M-1 was measured using a Microtrac Ultrafine Particle Analyzer (UPA) 150 from Microtrac, Inc. As used herein, median particle diameter refers to the 50th percentile such that 50% of the volume of the particles is composed of particles having diameters smaller than the indicated diameter. The median particle diameter for M-1 was 573 nm, which was deemed an undesirable size for most high quality ink jet applications, and upon incubation at 60° C. M-1 solidified.

Comparative Magenta Pigment Dispersion M-2

M-2 was prepared the same as M-1 except that the polymeric dispersant was CPD-2. The median particle size for M-2 was 15 nm.

Comparative Magenta Pigment Dispersion M-3

M-3 was prepared the same as M-1 except that the dispersant was CD-3 and the weight ratio of dispersant to pigment was 0.25:1.0. The median particle size of M-3 was 14 nm.

Comparative Magenta Pigment Dispersion M-4

M-4 was prepared the same as M-1, except the polymeric dispersant was CPD-4. The median particle size was 14 nm.

Comparative Yellow Pigment Dispersion Y-1

Y-1 was prepared the same as M-2 except that the pigment was Pigment Yellow 74 (Sun Chemical Corp.) and the weight ratio of polymeric dispersant to pigment was 0.50:1.0. The median particle size of Y-1 was 9 nm.

Comparative Yellow Pigment Dispersion Y-2

Y-2 was made the same as Y-1 except that the pigment was Pigment Yellow 155 (Clariant Corp.) and the dispersant was CD-3; weight ratio of dispersant to pigment was 0.25:1.0. The median particle size of Y-2 was 10 nm.

Comparative Black Pigment Dispersion K-1

K-1 was prepared the same as M-3 except that the pigment was Pigment Black 7 (carbon black Black Pearls® 880 from Cabot Corp.). The median particle size was 69 nm.

Comparative Black Pigment Dispersion K-2

K-2 was prepared the same as K-1 except that polymeric dispersant CPD-2 was used and the weight ratio of polymeric dispersant to pigment was 0.5:1.0. The median particle size was 68 nm.

Comparative Black Pigment Dispersion K-3

K-3 was Cab-O-Jet 300®, a self-dispersed carbon black pigment dispersion obtained from Cabot Corporation. The median particle size was about 120 nm.

Comparative Cyan Pigment Dispersion C-1

C-1 was prepared like M-3 except that PB15:3 was used as the pigment and the weight ratio of dispersant to pigment was 0.40:1.0. The median particle size was about 35 nm.

Preparation of Inventive Pigment Dispersions

Inventive Magenta Dispersion M-5

M-5 was prepared the same as M-1 except that polymeric dispersant P-1 was used. The median particle size was 16 nm.

Inventive Magenta Dispersion M-6

M-6 was prepared the same as M-1 except that polymeric dispersant P-3 was used. The median particle size was 15 nm.

Inventive Yellow Dispersion Y-3

Y-3 was prepared the same as Y-1 except that polymeric dispersant P-1 was used. The median particle size was 8 nm.

Inventive Yellow Dispersion Y-4

Y-4 was prepared like Y-3 except that Pigment Yellow 155 was used. The median particle size was 9 nm.

Inventive Yellow Dispersion Y-5

Y-5 was prepared like Y-3 except that polymeric dispersant P-2 was used. The median particle size was 9 nm.

Inventive Yellow Dispersion Y-6

Y-6 was prepared like Y-3 except that polymeric dispersant P-3 was used. The median particle size was 8 nm.

Inventive Cyan Dispersion C-2

C-2 was prepared like Y-4 except that Pigment Blue 15:3 was used and the weight ratio of polymeric dispersant to pigment was 0.40:1.0. The median particle size was 35 nm.

Inventive Black Dispersion K-4

K-4 was prepared like Y-6 except that Pigment Black 7 was used and the weight ratio of polymeric dispersant to pigment was 0.35:1.0. The median particle size was 68 nm.

Inventive Black Dispersion K-5

K-5 was prepared like K-4 except that polymeric dispersant P-1 was used. The median particle size was 66 nm.

Evaluation of Dispersion Particle Stability

Each of the pigment dispersions described above was subjected to elevated temperature by holding the samples for 1, 2, and 4 weeks at 60° C. in an enclosed bottle. UPA measurements were conducted to examine particle stability at each time interval. With the exception of control dispersion M-1 that solidified after one week, each of the dispersions above was found to be stable.

Preparation of Drop-On-Demand Ink Samples

Several ink samples were prepared with each of the dispersions cited above. The ink compositions are summarized Table I where all quantities are expressed as weight percent. Pigment concentrations in the inks were either 3.0 or 4.0 weight % for yellow and magenta, 4.0 weight % for black, and 2.5 weight % for cyan. The surfactant was Strodex® PK-90, a phosphate ester (Dexter Chemical L.L.C.).

TABLE I
Drop-on-Demand Ink Formulations

| | | Ethylene | Diethylene | | | |
|---|---|---|---|---|---|---|
| Ink Sample | Glycerol | Glycol | Glycol | PEG-400* | 2-Pyrrolidinone | Surfactant |
| A | 10 | 5 | — | — | — | 0.7 |
| B | 8 | — | 6 | — | — | 0.7 |
| C | — | — | — | 6 | 8 | 0.7 |
| D | — | — | — | 10 | 6 | 0.7 |

*Poly(ethylene glycol)-400 (average number-weighted molecular weight ca. 400)

Drop-On-Demand Ink Jet Printing and Receiver (Media) Types

Each of the dispersions was formulated according to one or more of the ink compositions described in Table I. The inks were then loaded into empty ink cartridges; the cartridges were then loaded into a Canon i960 Photo Printer (Canon U.S.A, Inc.) thermal ink jet printer. A stepped target was printed that provided uniform patches of ink laid down in 10% increments from 10 to 100%. The drivers for the CMYK channels were set up to lay down the same amount of ink from each channel. Status A RGB and Visible (neutral) patch densities were measured using a Spectralino instrument. The densities reported in Table II below are the maximum densities that were obtained (i.e., at 100% ink laydown). Two types on receivers were utilized: a porous glossy receiver (coated paper) typical of that used for high quality photo-printing and various plain (uncoated) papers typical of those used for general desktop printing. Epson Premium Photo Glossy Paper was used as the photo-receiver while Eastman Kodak Bright White Ink Jet Paper and Xerox Extra Bright Ink Jet Paper plain papers were used as the uncoated receivers.

Printed Image Density, Gloss, and Durability Results

Tables IIA, IIB, and IIC summarize the maximum density obtained on each type of receiver; also included in Table IIC is the visual gloss characterization and rub resistance (image durability) of each of the printed images on the photo-glossy Epson receiver.

TABLE IIA
Densities on Eastman Kodak Bright White Ink Jet Paper

| Dis- | | | Dispersion/ | | | | |
|---|---|---|---|---|---|---|---|
| persion | Pigment | Dispersant | Ink | Ink A | Ink B | Ink C | Ink D |
| M-1* | PR122 | CPD-1 | Comp. | N/A | N/A | N/A | N/A |
| M-2* | PR122 | CPD-2 | Comp. | 0.89 | 0.93 | 1.10 | 1.10 |
| M-3* | PR122 | CD-3 | Comp. | 0.83 | 0.85 | 0.86 | 0.87 |
| M-4* | PR122 | CPD-4 | Comp. | 0.87 | 0.89 | 1.05 | 1.12 |
| M-5* | PR122 | P-1 | Inv. | 1.0 | 1.02 | 1.22 | 1.20 |
| M-6* | PR122 | P-3 | Inv. | 0.99 | 1.07 | 1.20 | 1.19 |
| Y-2 | PY155 | CD-3 | Comp. | 0.72 | 0.72 | 0.73 | 0.73 |
| Y-4 | PY155 | P-1 | Inv. | 0.89 | — | 1.08 | — |
| Y-1* | PY74 | CPD-2 | Comp. | — | .91 | 1.07 | 1.11 |
| Y-3* | PY74 | P-1 | Inv. | — | .95 | 1.21 | — |
| Y-5* | PY74 | P-2 | Inv. | 0.97 | — | 1.23 | — |
| Y-6* | PY74 | P-3 | Inv. | — | 1.01 | 1.14 | 1.16 |
| C-1 | PB15:3 | CD-3 | Comp. | 0.81 | — | 0.83 | — |
| C-2 | PB15:3 | P-1 | Inv. | 0.87 | 0.91 | 1.04 | 1.20 |
| K-1* | PK7 | CD-3 | Comp. | 0.92 | 0.94 | 0.94 | — |
| K-2* | PK7 | CPD-2 | Comp. | .87 | 0.95 | — | — |
| K-3* | Cab-O- | Self-disp. | Comp. | 1.41 | 1.38 | — | — |
| | Jet 300 | | | | | | |
| K-4* | PK7 | P-3 | Inv. | — | 1.13 | 1.32 | — |
| K-5* | PK7 | P-1 | Inv. | .93 | 1.03 | 1.24 | 1.37 |

*indicates that pigment concentration in the ink is 4.0 wt. %. Others as indicated in ink description.

TABLE IIB
Densities on Xerox Extra Bright White Ink Jet Paper

| Dis- | | | Dispersion/ | | | | |
|---|---|---|---|---|---|---|---|
| persion | Pigment | Dispersant | Ink | Ink A | Ink B | Ink C | Ink D |
| M-1 | PR122 | CPD-1 | Comp. | N/A | N/A | N/A | N/A |
| M-2 | PR122 | CPD-2 | Comp. | 0.96 | 1.05 | — | 1.10 |
| M-3 | PR122 | CD-3 | Comp. | 0.83 | 0.84 | — | 0.86 |
| M-5 | PR122 | P-1 | Inv. | 1.03 | 1.12 | | 1.18 |
| Y-2 | PY155 | CD-3 | Comp. | 0.79 | 0.81 | 0.80 | — |
| Y-4 | PY155 | P-1 | Inv. | 0.89 | 0.89 | 1.02 | — |
| Y-1 | PY74 | CPD-2 | Comp. | 0.95 | .91 | 1.07 | 1.09 |
| Y-3 | PY74 | P-1 | Inv. | 1.08 | .95 | 1.21 | 1.27 |
| C-1 | PB15:3 | CD-3 | Comp. | 0.83 | — | 0.90 | — |
| C-2 | PB15:3 | P-1 | Inv. | 1.01 | 1.01 | 1.05 | 1.12 |
| K-1 | PK7 | CD-3 | Comp. | 0.95 | — | 1.02 | — |
| K-2 | PK7 | CPD-2 | Comp. | 0.87 | — | — | — |
| K-3 | Cab-O- | Self-disp. | Comp. | 1.41 | — | — | — |
| | Jet 300 | | | | | | |
| K-5 | PK7 | P-1 | Inv. | 1.09 | 1.29 | 1.31 | 1.41 |

All pigment concentrations in inks as cited in ink description.

TABLE IIC
Density, Image Gloss and Durability on Epson Premium Photo Glossy Paper

| | | | Dispersion/ | | | | | | Rub |
|---|---|---|---|---|---|---|---|---|---|
| Dispersion | Pigment | Dispersant | Ink | Ink A | Ink B | Ink C | Ink D | Gloss | Resistance |
| M-1 | PR122 | CPD-1 | Comp. | N/A | N/A | N/A | N/A | N/A | N/A |
| M-2 | PR122 | CPD-2 | Comp. | — | 2.03 | 2.05 | 2.02 | High | Very good |
| M-3 | PR122 | CD-3 | Comp. | — | 1.92 | — | 1.97 | High | Good |
| M-4 | PR122 | CPD-4 | Comp. | — | 2.1 | — | 2.07 | High | Very good |
| M-5 | PR122 | P-1 | Inv. | — | 2.19 | — | 2.1 | High | Very good |
| M-6 | PR122 | P-3 | Inv. | — | 2.15 | — | — | High | Very good |
| Y-2 | PY155 | CD-3 | Comp. | — | 1.59 | 1.81 | — | High | Good |
| Y-4 | PY155 | P-1 | Inv. | — | 2.15 | 2.12 | — | High | Very good |
| Y-1 | PY74 | CPD-2 | Comp. | 2.13 | 2.11 | — | 2.15 | High | Very good |
| Y-3 | PY74 | P-1 | Inv. | 2.23 | 2.15 | 2.22 | 2.26 | High | Very good |
| Y-5 | PY74 | P-2 | Inv. | 2.14 | — | — | 2.17 | High | Very good |
| Y-6 | PY74 | P-3 | Inv. | — | — | — | — | — | — |
| C-1 | PB15:3 | CD-3 | Comp. | 2.23 | — | 2.34 | — | High | Good |
| C-2 | PB15:3 | P-1 | Inv. | 2.57 | 2.57 | 2.17 | 2.32 | High | Very |
| | | | | | | | | | Good |
| K-1 | PK7 | CD-3 | Comp. | 2.52 | — | 2.42 | — | High | Good |
| K-2 | PK7 | CPD-2 | Comp. | 2.33 | — | — | — | High | Very good |
| K-3 | Cab-O- | Self-disp. | Comp. | 2.21 | — | — | — | Low | Poor |
| | Jet 300 | | | | | | | | |
| K-4 | PK7 | P-3 | Inv. | 2.20 | — | — | 2.35 | High | Very good |
| K-5 | PK7 | P-1 | Inv. | 2.12 | 2.22 | 2.42 | 2.51 | High | Very good |

All pigment concentrations in inks as cited in ink description.

Drop-On-Demand Dye-Based Ink Results

Dye-based inks that were provided with the Canon i960 printer were also printed on the Eastman Kodak Bright White Ink Jet Paper using the same target as that used for the data in Tables IIA-C. For comparative purposes the densities obtained at the 10% ink lay down were: M=1.27, Y=1.22, C=1.21, K (black)=1.28.

Drop-On-Demand Pigment-Based Ink Results

The comparative styrene-based polymeric dispersion, M-1, was found to be too large in particle size for high quality ink jet applications. After a period of time it solidified and therefore was not useful. As can be readily seen in Tables IIA and IIB from the densities produced on the two uncoated receivers (plain papers), the inventive dispersions provided significant density improvements over the other comparative M, Y, C, and K dispersions in the A and B pigmented ink compositions. Such density gains in the printed targets were readily visible to observers under normal viewing conditions. These density gains were seen in all of the pigment dispersions that were comprised of the inventive dispersants. Two of the comparative dispersants were based on acrylate monomers often identified in the art so it was therefore surprising to find that only those monomers containing the C12 and C18 chains were observed to provide the beneficial density gains, while maintaining good dispersion particle size and other desirable ink properties. For the black inks (K1-K5) it was found that the ink (K-3) made from the self-dispersed carbon black dispersion obtained from Cabot Corporation provided high density on the plain papers but easily smeared on both the uncoated and the photo-glossy papers (Table IIC); further this ink also exhibited very poor gloss on the photo-glossy receiver thus excluding it from practical use as a photo-black ink and limiting its use to text printing. An even more surprising result was found when inks comprising the inventive pigment dispersions and PEG compounds were tested—inks C and D in the Tables IIA-C. On the uncoated papers these inventive inks produced even higher densities than the A and B inventive inks and substantially more density than any of the comparative dispersions and their inks. The densities obtained from the inventive dispersions and inks as seen in Tables IIA and IIB are seen to approximate those produced by the dye-based inks: a result that has not been previously observed with pigmented inks comprising low molecular weight (<25,000) polymeric dispersants which can be easily and reliably jetted in thermal ink jet printers using small (1-5 picoliter) drop volumes.

Examination of Table IIC shows that on the photo-glossy receiver that high gloss, high density, and excellent durability have been achieved with the inventive dispersions and inks. It has been found that the inventive pigment dispersions and pigmented inks exhibit excellent results on both uncoated (plain papers) and coated (photo-glossy) receivers and thus making them highly useful for a variety of ink jet applications including printing with drop-on-demand thermal and piezoelectric drop ejection printers.

It can be readily appreciated from examination of Tables IIA and IIB that the inventive black dispersions and inks K-4, K-5 in Table IIA and K-5 in Table IIB exhibit black densities comparable to those of the self-dispersed carbon black pigmented ink, Cab-O-Jet 300, and the Canon i960 black ink. In view of these surprising results it is contemplated that the inventive pigmented black inks would be highly useful in printing both text black on plain papers and black and white photographic images on photo-glossy receivers. The poor rub and smear resistance and low gloss as shown in Table IIC of the Cab-O-Jet 300 ink precludes its use as black ink for photo printing on the glossy receiver whereas the inventive black pigmented inks exhibit excellent durability and gloss as shown in Table IIC. In many ink jet applications it is common to create photographic black and white images (so called process blacks) with CMY colorants (dyes or pigments) which have been dispersed with conventional dispersants while relying on inks comprising self-dispersed carbon blacks for printing of high density black text. A single black ink comprised of the inventive blacks ink would meet the essential requirements for both plain paper text printing and high quality photographic printing and thus eliminate the need for a special black ink or the complexity and cost that arises in utilizing CMY inks for process blacks (black and white photo printing). The inventive black inks would provide superior smear resistance on plain papers as compared with the self-dispersed black pigment thus providing even higher utility as a text black.

It is further contemplated that black inks comprising the polymeric dispersants described in of U.S. application Ser. No. 10/891,334, incorporated herein by reference, when comprised of hydrophobic to hydrophilic ratios suitable for higher plain paper densities would also be useful in providing a single black ink capable of meeting the requirements of both high quality text printing on plain papers and photo high quality printing of black and white images on glossy receivers. Said polymeric dispersants generally comprise an addition copolymer comprising at least one hydrophobic monomer type and at least one hydrophilic monomer type, wherein the polymeric dispersant comprises from 50 weight percent to 80 weight percent of hydrophobic monomers relative to the total weight of the polymeric dispersant, and wherein, when the polymer comprises more than one hydrophobic monomer type, at least 50 weight percent of the hydrophobic monomers relative to the total weight of the hydrophobic monomers is an acrylate comprising an aromatic group. The inks further comprise a black pigment and an aqueous media.

### Example 2

Preparation of Continuous Ink Jet Ink Samples

The suffix (C) designates control or comparative ink jet ink compositions, while the suffix (E) indicates example ink jet ink compositions. The symbol “Wt-%” indicates the ingredient weight percent. Carbon black pigment dispersion content is based on the weight percent of carbon black.

Comparative Black Pipment Dispersion K-6

K-6 was BONJET® BLACK M-800, a polymer-dispersed carbon black pigment dispersion obtained from Orient Corporation of America. The Material Safety Data Sheet disclosed the presence of the resin styrene-α-methylstyrene-acrylic acid copolymer and ethylene glycol. The median particle size was about 54 nm.

Comparative Black Pigment Dispersion K-7

K-7 was MICROJET® BLACK S-801®, a polymer-dispersed carbon black pigment dispersion obtained from Orient Chemical Corporation. The Material Safety Data Sheet disclosed the presence of the resin styrene-α-methylstyrene-acrylic acid copolymer and di(ethylene glycol). The median particle size was about 62 nm.

Comparative Black Pigment Dispersion K-8

K-8 was HOSTAJET® BLACK O-PT VP2676, a polymer-dispersed carbon black pigment dispersion obtained from Clariant Corporation. The Material Safety Data Sheet disclosed the presence of a proprietary ingredient and propylene glycol. The median particle size was about 91 nm.

Comparative Black Pigment Dispersion K-9

K-9 was BONJET® BLACK CW-3, a self-dispersed, surface-modified carbon black pigment dispersion obtained from Orient Corporation of America. The median particle size was about 84 nm.

Several different black ink jet ink compositions were prepared from some of the carbon black dispersions described previously and some commercially available carbon black pigment dispersions. The ink compositions are summarized Table III. Deionized, filtered water with a resistivity of 12 MΩ or higher constituted the balance of the composition as the primary vehicle or solvent.

TABLE III
Continuous Inkjet Ink Compositions

| Component | | | |
|---|---|---|---|
| (Wt-%) | Ink Type A | Ink Type B | Ink Type C |
| Vehicle | Water | Water | Water |
| Humectant/ | Glycerol (3.0) | Glycerol (5.0) | PEG-400 (4.0) |
| Penetrant | Di(ethylene | | |
| | glycol) (0.5) | | |
| | Poly(ethylene | | |
| | glycol) | | |
| | monobutyl ether | | |
| | (0.5) | | |
| | 1,2-Hexanediol | | |
| | (1.0) | | |
| Co-Solvent | 2-Pyrrolidinone | | 2-Pyrrolidinone |
| | (2.5) | | 2.0) |
| Biocide | PROXEL ® | PROXEL ® | PROXEL ® |
| | GXL (0.10) | GXL (0.10) | GXL (0.10) |
| | [Arch | [Arch | [Arch |
| | Chemicals, Inc.] | Chemicals, Inc.] | Chemicals, Inc.] |
| Surfactant | SURFYNOL ® | SURFYNOL ® | STRODEX ® |
| | 465 (0.25) | 465 (0.25) | PK-90 (0.40) |
| | [Air Products | [Air Products | [Dexter |
| | and Chemicals, | and Chemicals, | Chemical |
| | Inc.] | Inc.] | L.L.C.] |
| Colorant | Pigment (4.9) | Pigment (4.9) | Pigment (4.9) |

The black ink jet ink compositions were evaluated by application to paper substrates using a No. 6 wire-wound Mayer metering rod manufactured by either R.D. Specialties (Webster, N.Y.) or Industry Tech (Oldsmar, Fla.) and an ACCU-LAB® LABORATORY DRAWDOWN MACHINE manufactured by Industry Tech, in accord with U.S. Pat. No. 6, 280,512 B1 to Botros, EP 1 132 440 A2 to Botros et al., and U.S. Patent Application 2004/0220298 A1 to Kozee et al. After drying, the printed ink Status A visual optical density (OD) was measured using an X-RITE® 938 Spectrodensitometer. The wet rub durability test was performed by applying three drops of water to the inked substrate and using 10 strokes of a 100-g weight to abrade the surface, as generally reported (Rahman, L. Proc. TAPPI Spring Technical Conf and Trade Fair, 2003). Continuous ink jet ink composition optical density performance on plain, uncoated papers is shown in Tables IV and V, and optical density and wet rub durability on a gloss surface paper are recorded in Table VI.

TABLE IV
Performance of Ink Compositions on FINCH OPAQUE Bright
White Paper (Smooth Finish, 60 lb. Basis Weight)

| | | Ink Type | Ink Type | Ink Type |
|---|---|---|---|---|
| | | A | B | C |
| Dispersion | Polymeric Dispersant | OD | OD | OD |
| K-2 (C) | CPD-2 | 0.77 | 1.043 | 0.88 |
| K-2 (C) | CPD-2 (N,N- | 0.81 | 1.11 | 0.92 |
| | Dimethylethanolamine | | | |
| | Neutralization) | | | |
| K-4 (E) | P-2 | 0.87 | 1.25 | 1.26 |
| K-5 (E) | P-1 | 0.86 | 1.23 | 1.23 |
| K-6 (C) | styrene-α- | 0.79 | 0.79 | 0.76 |
| | methylstyrene-acrylic | | | |
| | acid copolymer | | | |
| K-7 (C) | styrene-α- | 0.79 | 0.84 | 0.76 |
| | methylstyrene-acrylic | | | |
| | acid copolymer | | | |
| K-8 (C) | Not Available | 0.86 | 1.14 | 0.89 |
| K-3 (C) | None | 1.01 | 1.42 | 1.24 |
| K-9 (C) | None | 1.38 | 1.41 | 1.41 |

TABLE V
Performance of Type B Ink Compositions and Comparative Inks on Various
Uncoated Plain Papers

| | | FINCH | INTERNATIONAL | INTERNATIONAL | |
|---|---|---|---|---|---|
| | | OPAQUE | PAPER | PAPER | SMURFIT |
| Dispersion in Ink | | Bright | DATASPEED | DATASPEED | STONE |
| Type B or | | White | Form Bond | Laser MOCR | Kraft Liner |
| Comparative Ink | Dispersant | OD | OD | OD | OD |
| K-2 (C) | CPD-2 | 1.04 | 0.95 | 1.15 | 1.23 |
| K-2 (C) | CPD-2 (N,N- | 1.20 | 0.97 | 1.16 | 1.24 |
| | Dimethylethanolamine | | | | |
| | Neutralization) | | | | |
| K-4 (E) | P-2 | 1.27 | 1.03 | 1.22 | 1.35 |
| K-5 (E) | P-1 | 1.23 | 1.02 | 1.21 | 1.30 |
| SCITEX ® 1021 | Not Available | 0.81 | 0.95 | 1.00 | 1.10 |
| Pigment Black | | | | | |
| Ink (C) | | | | | |
| KODAK | Not Available | 1.00 | 1.00 | 1.06 | 1.07 |
| VERSAMARK ® | | | | | |
| FD1100 Black | | | | | |
| Pigment Ink (C) | | | | | |

TABLE VI
Performance of Ink Compositions on STORA ENSO PRODUCTOLITH
Gloss Cover (Gloss Finish, 80 lb. Basis Weight)

| | | | | Ink Type B | |
|---|---|---|---|---|---|
| | | Ink Type A | Ink Type B | Wet Rub | Ink Type C |
| Dispersion | Dispersant | OD | OD | (%) | OD |
| K-2 (C) | CPD-2 | 2.22 | 2.44 | 2.1 | 2.53 |
| K-2 (C) | CPD-2 | 2.09 | 2.51 | 0.9 | 2.34 |
| | (N,N- | | | | |
| | Dimethylethanolamine | | | | |
| | Neutralization) | | | | |
| K-4 (E) | P-2 | 2.28 | 2.37 | 1.2 | 2.17 |
| K-5 (E) | P-1 | 2.47 | 2.85 | 0.7 | 2.63 |
| K-6 (C) | styrene-α- | 1.93 | 1.99 | 1.0 | 1.99 |
| | methylstyrene-acrylic | | | | |
| | acid copolymer | | | | |
| K-7 (C) | styrene-α- | 1.44 | 1.71 | 1.5 | 1.70 |
| | methylstyrene-acrylic | | | | |
| | acid copolymer | | | | |
| K-8 (C) | Not Available | 2.25 | 2.18 | 2.5 | 2.10 |
| K-3 (C) | None | 2.42 | 2.37 | 6.5 | 2.22 |
| K-9 (C) | None | 2.53 | 2.45 | 8.8 | 2.36 |

As can be seen from Table IV, diverse ink formulations suitable for continuous ink jet printing derived from the examples of the invention, dispersions K-4 and K-5, gave equal or superior optical density to other polymeric dispersant carbon black dispersions (e.g., K-2 and K-6-K-8) on a representative bond paper. Depending on the formulation properties, the inventive dispersions sometimes produced optical density comparable to chemically treated carbon black that is self-dispersing (e.g., K-3 and K-9) and known for excellent plain-paper printing performance. Table V compares the response of a subset of these carbon black dispersions using the Type B ink composition of Table III with a selection of other plain papers including unbleached, brown Kraft process liner. The use of amine neutralization with polymeric dispersant CPD-2, benzyl methacrylate-methacrylic acid copolymer, resulted in improved plain paper OD over alkali base neutralization, but still did not overcome the limitations of a polymeric dispersant that lacks a copolymer comprised of a hydrophobic methacrylate or acrylate monomer containing an aliphatic chain having greater than or equal to 12 carbons, as observed in Tables IV and V. Additionally, the Type B ink compositions employing dispersions of the invention show generally marked density improvement over commercially available pigment black continuous ink jet inks.

Table VI shows that excellent optical density performance was achieved with pigment ink compositions of the invention on glossy paper substrates that have been coated and calendared, without sacrifice of the durability of the ink image. The diverse ink compositions of Table III employing example dispersions K-4 or K-5 gave optical densities well over 2.0, in large excess of the desirable threshold value of 1.4 that provides a rich black appearance similar to electrophotographic printing, and comparable to or superior to comparative polymerically-dispersed or self-dispersed carbon black pigments in these same formulations. The wet rub durability of the ink image of Type B inks is also shown in Table VI. It is most desirable to minimize the wet rub transfer reported as a percentage, which is indicative of redissolution or redispersion of the colorant upon gentle abrasion or rubbing of the ink image in the presence of water. The test simulates the real world problem of printed bar codes being made illegible by exposure to rain or other liquids followed by handling. Glossy papers or cover stock are particularly susceptible to ink image abrasion, since the ink resides at the substrate surface after printing instead of penetrating into the paper's cellulose fibers as with plain bond papers, which affords the ink protection from rubbing or abrasion. It is seen in Table VI that all of the polymer-dispersed carbon black pigments exhibited very low wet rub transfer of less than about 3.0%, whereas self-dispersed carbon black pigments, which lack a film-forming polymer, in the same ink composition showed the typical behavior of easily observable transfer that was indicated by values in excess of about 5.0%. To provide additional perspective, it is worth noting that a typical soluble anionic dye-based continuous ink jet ink composition, KODAK VERSAMARK® FD1040 Black Ink, on the same glossy substrate in the same test produced a highly objectionable wet rub transfer of about 31%.

The invention has been described in detail with particular reference to certain preferred embodiments thereof, but it will be understood that variations and modifications can be effected within the spirit and scope of the invention.

1. An ink jet ink composition comprising an aqueous media and a pigment dispersion comprising a pigment and a polymeric dispersant wherein said polymeric dispersant is a copolymer comprising at least a hydrophobic methacrylate or acrylate monomer containing an aliphatic chain having greater than or equal to 12 carbons; and a hydrophilic methacrylic or acrylic acid monomer; wherein said copolymer comprises at least 10% by weight of the methacrylate or acrylate monomer and at least 5% by weight of the methacrylic or acrylic acid monomer; and wherein the copolymer comprises, in total, 20 to 95 weight % of hydrophobic monomer.

2. The ink jet ink composition of claim 1 wherein the said copolymer further comprises an additional hydrophobic monomer containing an aromatic group.

3. The ink jet ink composition of claim 1 wherein the monomer containing an aromatic group is benzyl methacrylate.

4. The ink jet ink of claim 1 wherein the copolymer comprises at least 20% by weight of the methacrylate or acrylate monomer.

5. The ink jet ink composition of claim 1 wherein the copolymer has a weight average molecular weight of less than 25,000.

6. The ink jet ink composition of claim 1 wherein the copolymer has a weight average molecular weight of less than 15,000

7. The ink jet ink composition of claim 1 wherein the copolymer has a weight average molecular weight of less than 10,000

8. The ink jet ink composition of claim 1 wherein the methacrylate or acrylate monomer is stearyl or lauryl methacrylate or acrylate.

9. The ink jet ink of claim 8 wherein the copolymer further comprises benzyl methacrylate.

10. The ink jet ink composition of claim 1 wherein the copolymer is a random copolymer.

11. The ink jet ink composition of claim 1 wherein the copolymer comprises at least 15% by weight of the methacrylic or acrylic acid monomer.

12. The ink jet ink composition of claim 1 further comprising tri(ethylene glycol) or poly(ethylene glycol).

13. The ink jet ink composition of claim 1 wherein the poly(ethylene glycol) has a number average molecular weight of 200 to 1000.

14. The ink jet ink composition of claim 1 wherein the pigment particles have a median particle diameter of less than 200 nm.

15. The ink jet ink composition of claim 1 wherein the pigment particles have a median particle diameter of less than 100 nm.

16. The ink jet ink composition of claim 1 wherein the weight ratio of the copolymer to the pigment is 0.15 to 0.8.

17. The ink jet ink composition of claim 1 wherein the pigment is carbon black.

18. The ink jet ink composition of claim 1 for use in a continuous ink jet printer, comprising less than about 8 percent by weight of total humectant.

19. The ink jet ink composition of claim 18 wherein the pigment is carbon black.

20. The ink jet ink composition of claim 1 for use in a continuous ink jet printer wherein the copolymer has been reacted with an organic base to deprotonate acidic functional groups.

21. An ink jet printing method comprising the steps of:
A) providing an ink jet printer that is responsive to digital data signals;
B) loading the printer with an ink jet recording element comprising an uncoated or coated ink receiving substrate;
C) loading the printer with an ink jet ink composition comprising a pigment dispersion, water and a water-miscible organic compound; wherein the pigment dispersion comprises pigment particles having a median diameter of 200 nm or less, and a polymeric dispersant that is a copolymer comprising at least a hydrophobic methacrylate or acrylate monomer containing an aliphatic chain having greater than or equal to 12 carbons; and a hydrophilic methacrylic or acrylic acid monomer; wherein said copolymer comprises at least 10% by weight of the methacrylate or acrylate monomer and at least 5% by weight of the methacrylic or acrylic acid monomer; and wherein the copolymer comprises, in total, 20 to 95 weight % of hydrophobic monomer, wherein the polymeric dispersant has a weight average molecular weight of less than 25,000; and
D) printing on the image receiving element using the ink jet composition in response to the digital data signals.

22. The method of claim 21 wherein the ink jet printer is a drop on demand printer.

23. The method of claim 21 wherein the ink jet printer is a continuous ink jet printer.

24. The method of claim 22 wherein the ink jet printer is a thermal drop on demand printer.

25. The method of claim 21 wherein the ink jet ink composition is a black ink and wherein the printer utilizes the same black ink composition for both text printing and photo printing.

26. An ink jet printing method comprising the steps of:
A) providing an ink jet printer that is responsive to digital data signals;
B) loading the printer with an ink jet recording element comprising an uncoated or coated ink receiving substrate;
C) loading the printer with a black ink jet ink composition comprising a black pigment dispersion and an aqueous media; wherein the pigment dispersion comprises pigment particles having a median diameter of 200 nm or less, and a polymeric dispersant comprising an addition copolymer comprising at least one hydrophobic monomer type and at least one hydrophilic monomer type, wherein the polymeric dispersant comprises from 50 weight percent to 80 weight percent of hydrophobic monomers relative to the total weight of the polymeric dispersant, and wherein, when the polymer comprises more than one hydrophobic monomer type, at least 50 weight percent of the hydrophobic monomers relative to the total weight of the hydrophobic monomers is an acrylate comprising an aromatic group; and
D) printing on the image receiving element using the ink jet composition in response to the digital data signals; wherein the printer utilizes the same black ink composition for both text printing and photo printing.
